(19) United States
(12) Patent Application Publication
(10) Pub. No.: US 2015/0062293 A1
(43) Pub. Date: Mar. 5, 2015

(54) DIGITAL DEVICE AND METHOD OF CONTROLLING THEREFOR

(71) Applicant: LG ELECTRONICS INC., Seoul (KR)

(72) Inventors: Eunhyung CHO, Seoul (KR); Sinae CHUN, Seoul (KR); Jongho KIM, Seoul (KR); Jihwan KIM, Seoul (KR)

(73) Assignee: LG ELECTRONICS INC., Seoul (KR)

(21) Appl. No.: 14/092,373

(22) Filed: Nov. 27, 2013

(30) Foreign Application Priority Data
Sep. 2, 2013 (KR) 10-2013-0104709

(51) Int. Cl. H04N 5/232; G02B 27/01

(52) U.S. Cl. CPC H04N 5/23238; G02B 27/0172
USPC 348/39

(57) ABSTRACT

The present specification relates to a digital device and a method of controlling therefor, and more particularly, to a method of displaying a sensed image according to a photographing angle of a camera unit and a photographing angular speed of the camera unit.

Pursuant to 35 U.S.C. §119(a), this application claims the benefit of the Korean Patent Application No. 10-2013-0104709, filed on Sep. 2, 2013, which is hereby incorporated by reference as if fully set forth herein.

### BACKGROUND OF THE INVENTION

1. Field of the Invention

The present specification relates to a digital device and a method of controlling therefor, and more particularly, to a method of displaying a sensed image according to a photographing angle of a camera unit and a photographing angular speed of the camera unit in a manner of as it is or reversing the left and the right of the sensed image.

2. Discussion of the Related Art

Generally, a head mounted display indicates various digital devices enabling a user to receive a multimedia content in a manner of being mounted on the head of the user like glasses. According to a trend of lightening and miniaturizing of a digital device, various wearable computers have been developed so far and the HMD is also widely used. The HMD can provide various conveniences as well as a simple display function to a user in a manner of being combined with an augmented reality technology and an N screen technology.

Recently, as technologies develop, various camera lenses have been developed. For instance, in case of a camera capable of rotating 360 degrees in a manner of being installed in a device, the camera is used for such a security camera as a CCTV. And, for instance, in case of a camera of a wide view angle such as a fish-eye lens, it can be used for taking a picture of which requires a special effect.

The aforementioned special camera lens may be usable in a manner of being installed in various digital devices. For instance, the lens capable of rotating or the fish-eye lens can be used in a manner of being installed in a black box for a security or surveillance purpose.

### SUMMARY OF THE INVENTION

Accordingly, the present specification is directed to an apparatus and method thereof that substantially obviate one or more problems due to limitations and disadvantages of the related art.

According to one embodiment, in case that surrounding environment is sensed using a camera capable of horizontally rotating or a camera of a wide view angle, an object of the present specification is to provide a sensed image as it is or a left/right reversed sensed image to a user.

According to a different embodiment, in case that a photographing angle of a camera exceeds 90 degrees, if the photographing angle changes into a less than a predetermined angular speed in a manner of comparing a change of the photographing angle with the predetermined angular speed, an object of the present specification is to provide a left/right reversed sensed image to a user.

According to a different embodiment, in case that a photographing angle increases or decreases, an object of the present specification is to provide a sensed image as it is or a left/right reversed sensed image to a user.

According to a different embodiment, in case that a camera capable of rotating or a camera of a wide view angle is installed in such various devices as a head mounted display, a foldable display device, a vehicle, and the like, an object of the present specification is to provide a sensed image to a user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a digital device includes a camera unit configured to sense an image, a display unit configured to display the image sensed by the camera unit, an angle sensing unit configured to sense a photographing angle of the camera unit, and a processor configured to control the camera unit, the display unit, and the angle sensing unit, wherein the processor is further configured to: when the photographing angle of the camera unit corresponds to a first angle range, provide a first display mode for displaying a sensed image according to the photographing angle, when the photographing angle of the camera unit corresponds to a second angle range, if a change of the photographing angle of the camera unit exceeds a predetermined angular speed, provide the first display mode, if the change of the photographing angle of the camera unit is within the predetermined angular speed, provide a second display mode for displaying a left/right reversed image of the sensed image according to the photographing angle, if the change of the photographing angle of the camera unit changes from a speed less than the predetermined angular speed to the speed exceeding the predetermined angular speed, provide the second display mode.

To achieve these objects and other advantages and in accordance with the purpose of the invention, as embodied and broadly described herein, according to a different embodiment, a method of controlling a digital device includes the steps of when a photographing angle of a camera unit corresponds to a first angle range, providing a first display mode for displaying a sensed image according to the photographing angle, when the photographing angle of the camera unit corresponds to a second angle range, if a change of the photographing angle of the camera unit exceeds a predetermined angular speed, providing the first display mode, if the change of the photographing angle of the camera unit is within the predetermined angular speed, providing a second display mode for displaying a left/right reversed image of the sensed image according to the photographing angle, and if the change of the photographing angle of the camera unit changes from a speed less than the predetermined angular speed to the speed exceeding the predetermined angular speed, providing the second display mode.

According to one embodiment, in case that a user uses a digital device equipped with a camera capable of horizontally rotating or a camera of a wide view angle, the user can easily recognize surrounding environment via the camera without moving to see the surrounding environment positioned at a side or a rear of the user.

According to a different embodiment, in case that a photographing angle of a camera unit corresponds to a second angle range, if a change of the photographing angle exceeds a predetermined angular speed, a user can receive an image maintained a sensed image as it is.

According to a different embodiment, in case that a photographing angle of a camera unit corresponds to a second angle range, if a change of the photographing angle is within a predetermined angular speed, a user can more naturally recognize a surrounding environment positioned at a side or a rear of the user in a manner of being provided a left/right reversed image of a sensed image.

According to a different embodiment, in case that a camera capable of horizontally rotating or a camera of a wide view angle is installed in a digital device, images of various angles can be sensed by a movement of the digital device without moving of a user.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a digital device according to the present specification;

FIG. 2 is a diagram of a photographing angle of a digital device according to the present specification;

FIG. 3a and FIG. 3b is a diagram of an image sensed by a camera unit when the camera unit capable of horizontally rotating is installed in a digital device according to the present specification;

FIG. 4a and FIG. 4b is a diagram of an image sensed by a camera unit when an view angle of the camera unit installed in a digital device according to the present specification exceeds 180 degrees;

FIG. 5 is a diagram of an embodiment when a photographing angle of a camera unit according to the present specification corresponds to a first angle range;

FIG. 6 is a diagram of a first embodiment when a photographing angle of a camera unit according to the present specification corresponds to a second angle range;

FIG. 7 is a diagram of a second embodiment when a photographing angle of a camera unit according to the present specification corresponds to a second angle range;

FIG. 8 is a diagram of a third embodiment when a photographing angle of a camera unit according to the present specification corresponds to a second angle range;

FIG. 9 is a diagram of a fourth embodiment when a photographing angle of a camera unit according to the present specification corresponds to a second angle range;

FIG. 10a and FIG. 10b is a diagram of an embodiment when a digital device according to the present specification is a camera installed in a vehicle;

FIG. 11 is a diagram of an embodiment when a digital device according to the present specification corresponds to a foldable display device;

FIG. 12 is a flowchart of a method of controlling a digital device according to the present specification.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present specification. Wherever possible, the same reference numbers will be used throughout the drawings to refer to the same or similar parts.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

Moreover, while the embodiments have been concretely described with reference to the attached diagrams and the contents written on the diagrams, the present specification may be non-restricted or non-limited to the embodiments.

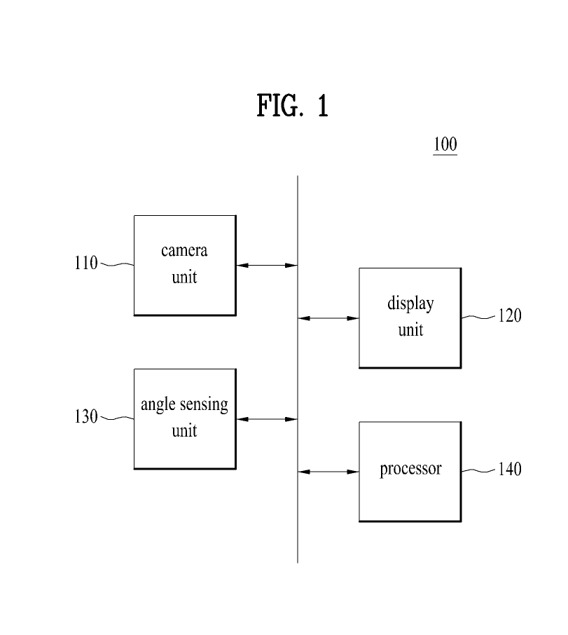

FIG. 1 is a block diagram of a digital device according to the present specification. Yet, FIG. 1 is just one embodiment and a part of configuring module can be deleted or a new configuring module can be added according to the necessity of those skilled in the art.

As depicted in FIG. 1, a digital device 100 can include a camera unit 110, a display unit 120, an angle sensing unit 130, and a processor 140.

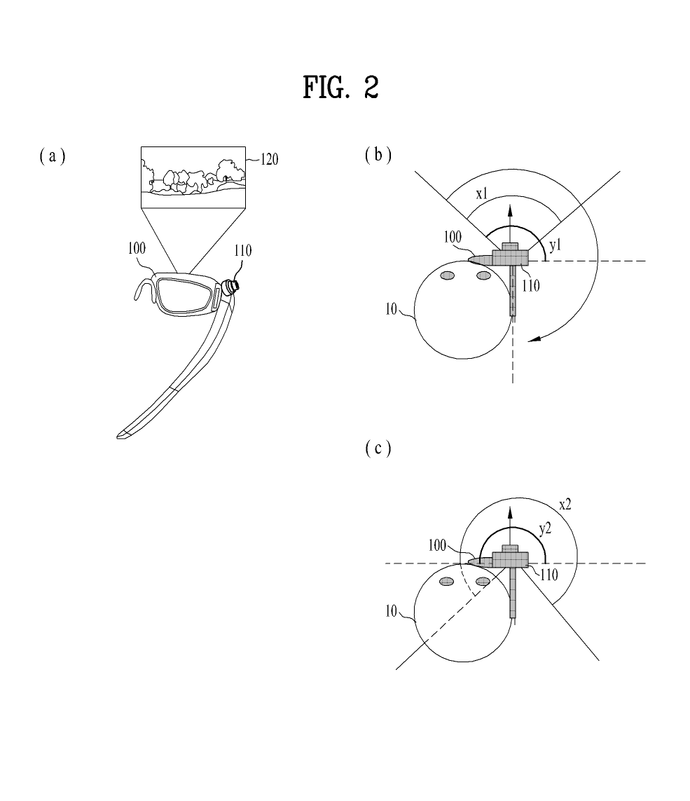

First of all, the digital device 100 can include such various devices capable of displaying an image as a PDA (personal digital assistant), a notebook, a tablet PC, a smartphone, and the like. And, the digital device 100 can include various devices capable of sensing an image in a manner of being equipped with the camera unit 110. In the present specification, the digital device 100 may correspond to a head mounted display (HMD), a foldable display (including 2 folders, 3 folders, and the like), a vehicle, or the like. In the following description, assume that the digital device 100 corresponds to the HMD in FIG. 2 to FIG. 9.

The camera unit 110 can sense an image of a front direction. In this case, the front direction may indicate a direction at which the camera unit 110 of the digital device 100 faces. And, the camera unit 110 takes a picture of an image within an view angle area and can provide the image to the processor 140.

In the present specification, if the camera unit 110 is capable of horizontally rotating, the camera unit 110 can provide an image sensed according to a horizontal rotation to the processor 140. And, a horizontal rotation angle may correspond to one point in a direction at which the camera unit 110 faces in a default state. And, if an view angle of the camera unit 110 exceeds 180 degrees (e.g., a fish-eye lens) in the present specification, the camera unit 110 can provide an image sensed in a range exceeding 180 degrees to the processor 140 at the same time.

And, if the digital device 100 corresponds to a HMD in the present specification, the front direction may indicate a direction corresponding to a view of a user wearing the HMD. In particular, the camera unit 110 can sense an image of a direction, which corresponds to the view of the user wearing the HMD.

The display unit 120 can output an image in a display screen. And, the display unit 120 can output an image based on content executed by the processor 140 or a control command of the processor 140. For instance, the content may include various videos, images, and the like. In the present specification, the display unit 120 can display an image sensed by the camera unit 110.

Meanwhile, if the digital device 100 corresponds to the HMD in the present specification, an image can be outputted in the display screen in various modes. In one embodiment, the HMD can output an image in a see-through mode. In this case, the see-through mode indicates that the display screen is transparent. The see-through mode indicates a mode capable of using content while a user wearing the HMD is recognizing the surrounding environment. In another embodiment, the HMD can output an image in a front-light mode. In this case, the front-light mode indicates a mode capable of displaying an image to which a light is reflected without directly projecting to eyes via such a reflector as a mirror.

And, as a further different example, the HMD can output an image in a see-closed mode. In this case, the see-closed mode indicates a mode not capable of seeing an external environment via the display screen and capable of using contents via the display screen. The present specification is explained under an assumption that the HMD displays an image sensed by the camera unit 110 in the see-through mode or the front-light mode.

The angle sensing unit 130 senses a photographing angle of the camera unit 110 using at least one sensor installed in the digital device 100 and can deliver a sensed result to the processor 140 in a signal form. If the camera unit 110 is capable of horizontally rotating, the photographing angle may indicate an angle of which the camera unit is horizontally rotated on the basis of a predetermined point in the present specification. And, if an view angle of the camera unit 110 exceeds 180 degrees, an image sensed by the camera unit 110 is divided into at least one area and the photographing angle may indicate an angle corresponding to the divided at least one area in the present specification. Regarding this, it shall be described again in FIG. 2.

The processor 140 processes a data, controls each unit of the aforementioned digital device 100, and can control transmission/reception of a data between units.

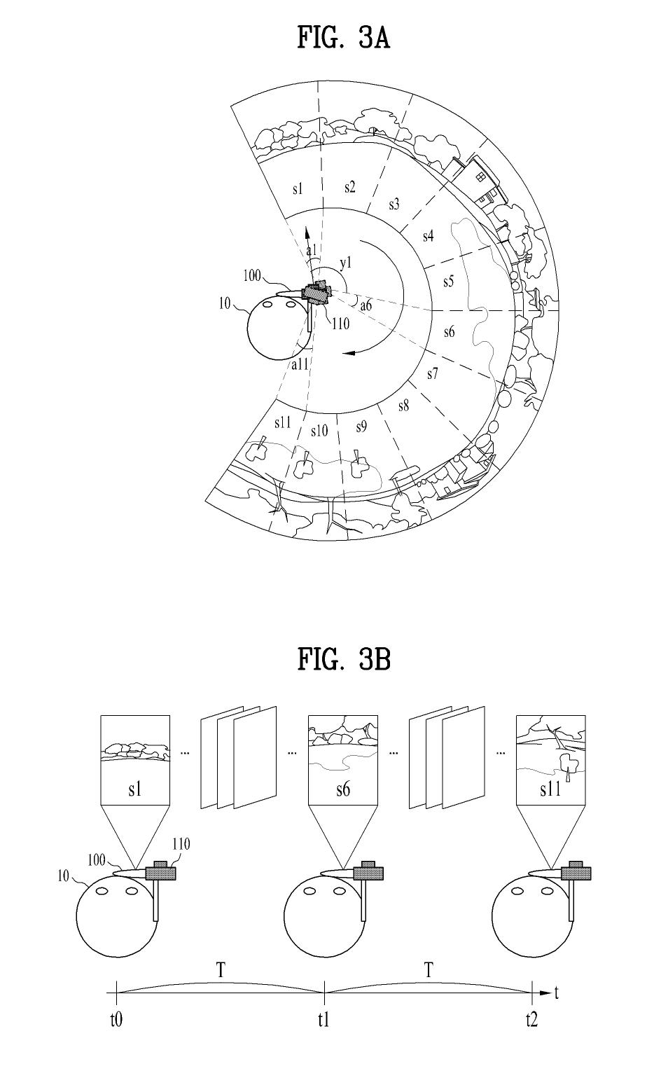

The processor 140 can provide various display modes to the display unit 120 according to a photographing angle of the camera unit 110 in the present specification. For instance, if the photographing angle of the camera unit 110 corresponds to a first angle range, the processor 140 can provide a first display mode configured to display a sensed image according to the photographing angle. And, for instance, if the photographing angle of the camera unit 110 corresponds to a second angle range, the processor 140 can provide a second display mode configured to display a sensed image in a manner of reversing the left and the right of the sensed image according to the aforementioned first display mode or the photographing angle. Regarding this, if the photographing angle of the camera unit 110 corresponds to the second angle range, a provided display mode may vary according to whether a change of the photographing angle corresponds to a predetermined angular speed. Regarding this, it shall be described in detail in FIG. 3 to FIG. 9.

As an embodiment of the present specification, operations performed by the digital device 100 can be controlled by the processor 140. For clarity, these operations are commonly depicted and explained in a manner that the mobile device 100 performs/controls the operations in the following description and diagrams.

Meanwhile, although it is not depicted in FIG. 1, the digital device 100 can include a sensor unit, a storage unit, a communication unit, a power unit, and the like. Besides the aforementioned angle sensing unit 130, the sensor unit can include at least one sensing means. As an embodiment, the at least one sensing means can include such a sensing means as a gravity sensor, a terrestrial magnetism sensor, a motion sensor, a gyroscope sensor, an acceleration sensor, an infrared sensor, a tilt (inclination) sensor, a brightness sensor, an altitude sensor, a smell sensor, a temperature sensor, a depth sensor, a pressure sensor, a bending sensor, an audio sensor, a video sensor, a GPS (global positioning system) sensor, a touch sensor, a grip sensor, and the like.

The storage unit can store such various digital data as a video, an audio, an image, an application, and the like. The storage unit can store a program configured to process and control the processor and can perform a function of temporarily storing input/output data. For instance, the storage unit can be situated at the inside/outside of the digital device 100.

The communication unit performs a communication with an external device using various protocols and can transceive a data using the various protocols. And, the communication unit can transceive such a digital data as content and the like by accessing a network in wired or wireless. For instance, the communication unit can use such a communication standard as WLAN (Wireless LAN) (Wi-Fi), Wibro (Wireless broadband), Wimax (World Interoperability for Microwave Access), HADPA (High Speed Downlink Packet Access), and the like.

The power unit is a power source connected to an internal battery or an external power supply of the digital device 100. The power unit can supply power to the digital device 100.

The digital device 100 depicted in FIG. 1 is a block diagram according to one embodiment. Blocks represented in a manner of being separated indicate the logically distinguished elements of the digital device 100. Hence, the elements of the aforementioned digital device 100 can be equipped with a single chip or a plurality of chips according to the design of the device.

FIG. 2 is a diagram of a photographing angle of a digital device according to the present specification. More specifically, FIG. 2 (a) indicates a configuration of the digital device 100, FIG. 2 (b) indicates a photographing angle of the camera unit 110 when the camera unit is capable of horizontally rotating, and FIG. 2 (c) indicates the photographing angle of the camera unit 110 when an view angle of the camera unit exceeds 180 degrees.

Referring to FIG. 2 (a), the camera unit 110 can be installed in the front side of the digital device 100. In this case, the digital device may correspond to a HMD. For instance, the digital device 100 can be equipped with the camera unit 110 at one side of the front side. In this case, the one side may correspond to a point of the left, the right, the middle, or the like of the digital device 100. Yet, since the present specification describes the camera unit 110 capable of horizontally rotating or an view angle exceeding 180 degrees, it is more efficient for the camera unit 110 to be installed in the left or the right side of the digital device 100 to sense an external picture.

And, as depicted in FIG. 2 (a), the digital device 100 can display an image sensed by the camera unit 110 in the display unit 120. As mentioned earlier in FIG. 1, the digital device 100 can display an image in the see-through mode or the front-light mode.

FIG. 2 (b) indicates when the camera unit 110 is capable of horizontally rotating. In this case, the camera unit 110 can rotate to the left or to the right on the basis of a predetermined point (arrow) depicted in FIG. 2 (b). And, the camera unit 110 can sense an image within a predetermined view angle (x1) area. For instance, the predetermined view angle (x1) may correspond to 60 degrees.

And, the photographing angle of the digital device 100 can include a first angle range and a second angle range. For instance, the first angle range may correspond to a range ranging from the view angle of the camera unit 110 to an y1 angle when the camera unit faces the predetermined point (arrow). In this case, the y1 angle may correspond to 90 degrees. And, for instance, the second angle range can include an angle of which the photographing angle of the camera unit 110 exceeds the y1 angle. In particular, the second angle range may correspond to an angle excluding the first angle range. Regarding to the horizontal rotation of the camera unit 110, it shall be described again in FIG. 3. For instance, the predetermined point (arrow) may correspond to one point of a direction at which the camera unit 100 faces in a default state.

FIG. 2 (c) indicates when the view angle of the camera unit 110 exceeds 180 degrees. Referring to FIG. 2 (c), the camera unit 110 can sense an image within a predetermined view angle (x2) area. For instance, the predetermined view angle (x2) may correspond to 270 degrees. In particular, the digital device 100 can sense an image of a wide angle at a time using the camera unit 110 depicted in FIG. 2 (c).

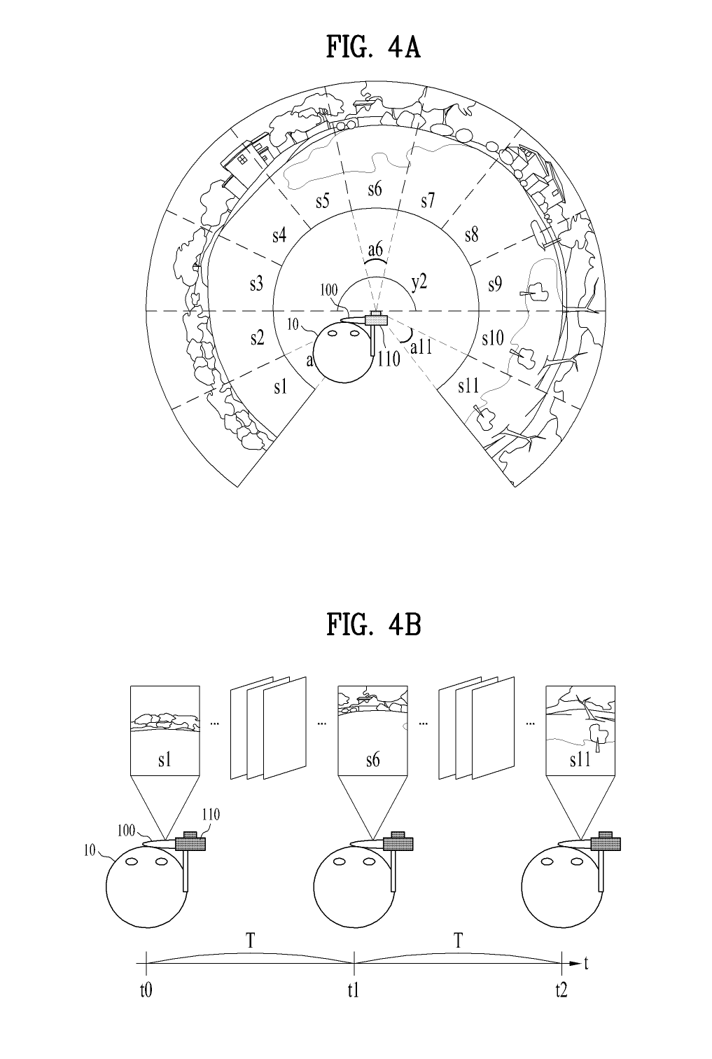

Similar to the aforementioned FIG. 2 (b), the photographing angle of the digital device 100 can include a first angle range and a second angle range. For instance, the first angle range may correspond to an y2 angle. In this case, the y2 angle may correspond to 180 degrees. And, for instance, the second angle range can include an angle of which the photographing angle of the camera unit 110 exceeds the y2 angle. Regarding to when the view angle of the camera unit 110 exceeds 180 degrees, it shall be described again in FIG. 4.

FIG. 3 is a diagram of an image sensed by a camera unit when the camera unit capable of horizontally rotating is installed in a digital device according to the present specification. More specifically, FIG. 3a indicates a surrounding environment sensed by the camera unit 110 capable of horizontally rotating and FIG. 3b indicates that images sensed by the camera unit in FIG. 3a are displayed in the display unit 120.

The digital device 100 can sense a surrounding environment of various angles using the camera unit 110 capable of horizontally rotating. In this case, the surrounding environment can include an object, a person, and the like positioned in the vicinity of a place at which the digital device 100 is positioned. For instance, as depicted in FIG. 3a, the digital device 100 can sense a corresponding scene s1 to s11 according to the photographing angle, i.e., a1 to a11 of the camera unit 110. And, the digital device can sense a surrounding environment of a different angle not depicted in FIG. 3a.

And, the digital device 100 can display the image sensed by the camera unit 110 in the display unit 120. For instance, as depicted in FIG. 3b, the digital device 100 can display the image s1 to s11, which are sensed as the camera unit 110 rotates to a1 to a11 photographing angle, in the display unit 120.

The digital device 100 can sense an view angle, i.e., an image s1 of the a1 photographing angle of the camera unit 110 in a default state of the camera unit 110. By doing so, a user 10 can see the s1 via the display unit 120. And, if the camera unit horizontally rotates as much as 90 degrees to the right, the digital device 100 can sense an view angle of the camera unit 110, i.e., a scene s6 of an a6 photographing angle. By doing so, the user 10 can see the s6 via the display unit 120. And, if the camera unit horizontally rotates as much as 180 degrees to the right, the digital device 100 can sense an view angle of the camera unit 110, i.e., a scene s11 of an a11 photographing angle. By doing so, the user 10 can see the s11 via the display unit 120. In particular, according to an embodiment of FIG. 3, the user 10 can easily see the surrounding environment of not a front but a side or a rear via the camera rotation without such a movement of the user as turning the user's head to the left and the right, and the like.

And, if the camera unit 110 rotates at a constant angular speed, the digital device 100 can provide an image sensed by the camera unit 110 to the display unit 120 as it is. More specifically, as depicted in FIG. 3b, the digital device 100 can display a sensed image s1 on a t0 time. And, the digital device 100 can display a sensed image s6 on a t1 time where a T time elapsed from the t0 time. And, the digital device 100 can display a sensed image s10 on a t2 time where the T time elapsed from the t1 time. This may correspond to when the digital device 100 captures an image or a video.

FIG. 4 is a diagram of an image sensed by a camera unit when an view angle of the camera unit installed in a digital device according to the present specification exceeds 180 degrees. More specifically, FIG. 4a indicates a surrounding environment sensed by the camera unit 110 of which an view angle exceeds 180 degrees and FIG. 4b indicates that images sensed by the camera unit 110 in FIG. 4a are displayed in the display unit 120.

As mentioned earlier in FIG. 2, the camera unit 110 of which an view angle exceeds 180 degrees can sense a surrounding environment of an angle exceeding 180 degrees at a time unlike the aforementioned camera unit of FIG. 3. In this case, the digital device 100 can provide a sensed image to a user at a time or can show the sensed image to the user in a manner of dividing the sensed image into at least one angle range. Hence, the digital device 100 can divide the image sensed by the camera unit 110 into at least one photographing angle.

For instance, as depicted in FIG. 4a, the digital device 100 can divide the view angle of the camera unit 110 having the view angle of 270 degrees into 11 photographing angles. In this case, each of the photographing angles indicates not the view angle actually sensed by the camera unit 110 in real time but at least a part of the view angle among the whole angles of view. And, the digital device 100 can map a part corresponding to the photographing angle among the divided at least one photographing angle and the sensed image. In particular, as depicted in FIG. 4a, the digital device 100 divides the 11 areas into a1 to a11 photographing angles and s1 to s11 scenes and can map each of the photographing angles to each of the scenes, respectively.

And, the digital device 100 can display the image sensed by the camera unit 110 in the display unit 120. More specifically, as depicted in FIG. 4b, as the photographing angle of the camera unit 110 is divided into a1 to a11, the digital device 100 can display the image s1 to s11 corresponding to each of the photographing angles in the display unit 120.

And, as the photographing angle changes, the digital device 100 can provide an image corresponding to the photographing angle in the display unit as it is. In this case, the change of the photographing angle indicates not an actual change of the view angle of the camera unit but a change of an angle becoming a display target among the whole angles of view. More specifically, as depicted in FIG. 4b, the digital device 100 can display an s1 among the sensed images on a t0 time. And, the digital device 100 can display an s6 among the sensed images on a t1 time where T time elapsed from the t0 time. And, the digital device 100 can display an s11 among the sensed images on a t2 time where T time elapsed from the t1 time. The may correspond to when the digital device 100 captures an image or a video.

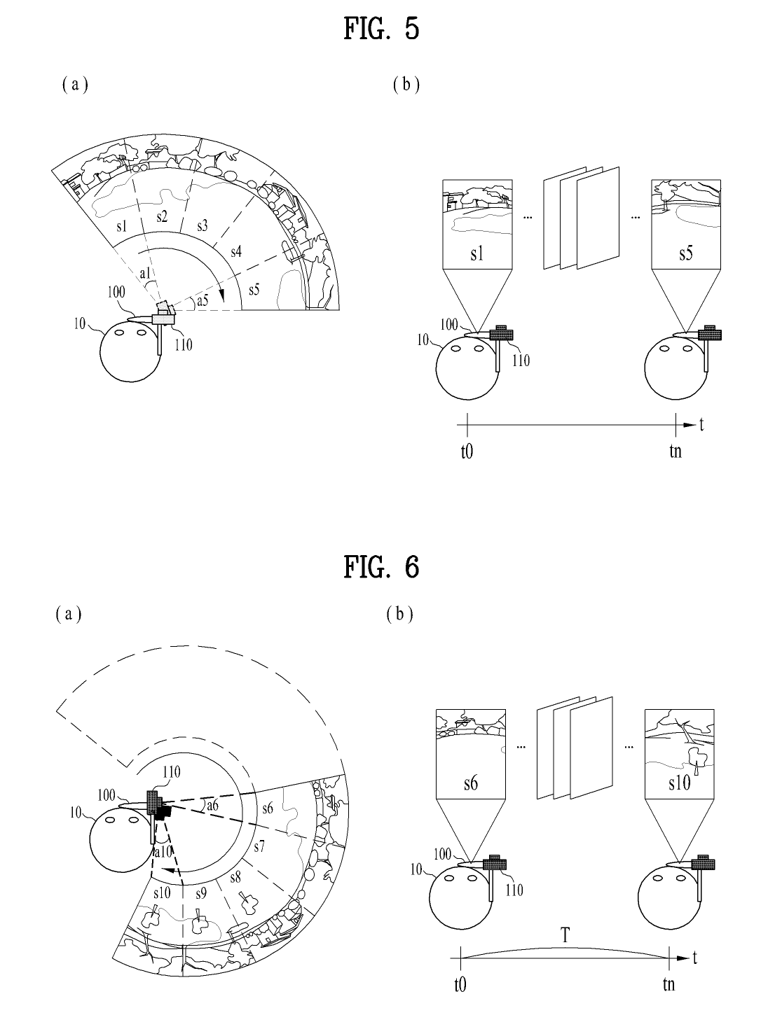

As depicted in FIG. 4 and FIG. 5, the digital device can display the sensed image as it is irrespective of whether the photographing angle corresponds to the first angle range or the second angle range. This corresponds to when the sensed image is displayed as it is in the second angle range without reversing the left and the right of the sensed image. This may be more natural in an image capture or a video capture.

In one embodiment, in case of capturing an image sensed by the camera unit, the digital device 100 can capture an image provided in a first display mode irrespective of the photographing angle of the camera unit 110. In another embodiment, in case of contiguously capturing the image sensed by the camera unit, the digital device can capture a video provided in the first display mode irrespective of the photographing angle of the camera unit. In this case, the first display mode may indicate a mode for displaying the sensed image as it is.

Yet, when an image preview interface is provided to a user 10 instead of the image capture or the video capture, if an image sensed in the second angle range is provided to the user without reversing the left and the right of the image, the user may feel inconvenience or confusion for the left/right reverse.

Hence, in case of providing the image preview interface to the user, although it is necessary to provide the sensed image to the user as it is, in some cases, it may be also necessary to provide the left/right reversed image of the sensed image to the user. For instance, the digital device 100 can provide the image sensed by the camera unit 110 in various modes in consideration of when a change of the photographing angle is faster or slower than a predetermined angular speed. Regarding this, it shall be described in detail in FIG. 5 to FIG. 9.

Meanwhile, in relation to the camera unit capable of horizontally rotating mentioned earlier in FIG. 3 and the camera unit having an view angle exceeding 180 degrees mentioned earlier in FIG. 4, it can be considered as an identical camera unit in that a sensed image is displayed according to a photographing angle. Hence, the camera unit capable of horizontally rotating is used as a representative example in embodiments of FIG. 5 to FIG. 9 among the camera unit capable of horizontally rotating and the camera unit having an view angle exceeding 180 degrees to explain the embodiments in the following description. And, since FIG. 5 to FIG. 9 indicates when an image preview interface is provided to a user, FIG. 5 to FIG. 9 intends to indicate an environment recognized not for an image or video capture but for an actual user.

FIG. 5 is a diagram of an embodiment when a photographing angle of a camera unit according to the present specification corresponds to a first angle range. More specifically, FIG. 5 (a) indicates a change of the photographing angle according to a horizontal rotation of the camera unit 110 and FIG. 5 (b) indicates that an image sensed by the camera unit 110 is provided to a user.

The digital device 100 can start an image sensing on the basis of a predetermined point of the camera unit 110. In this case, as mentioned earlier in FIG. 2, the predetermined point indicates a default state of the camera unit 110, i.e., a state that the camera unit 110 faces a front side of the digital device 100.

When the camera unit 110 operates, the digital device 100 can sense an external environment in various angles as the camera unit 110 rotates. FIG. 5 (a) indicates that the camera unit 110 horizontally rotates to the right from the default state. Referring to FIG. 5 (a), the digital device 100 can detect what the camera unit 110 senses a surrounding environment from an a1 photographing angle to an a5 photographing angle. In this case, the a1 photographing angle to the a5 photographing angle may correspond to a first angle range. The first angle range may indicate an angle that a user 10 feels no inconvenience although an image sensed by the camera unit 110 is provided to the user without reversing the left and the right of the sensed image. For instance, the first angle range may correspond to 0 to ±90 degrees. Meanwhile, unlike FIG. 5 (a), when the camera unit 110 rotates to the left from the default state, identical content can be applied as well.

As the camera unit 110 horizontally rotates, the digital device can provide images sensed according to the horizontal rotation to the user 10. In particular, if the camera unit horizontally rotates in the first angle range, the digital device can provide a first display mode for providing a sensed image to the user irrespective of an angular speed of the horizontal rotation. As depicted in FIG. 5 (b), the digital device can provide images sensed from a t0 time to a to time, while the rotation angle of the camera unit 110 becomes the a1 to the a5, in particular, while the sensed image reaching from the s1 to the s5, to the user 10.

In one embodiment, if an angular speed of the horizontal rotation from the a1 photographing angle to the a5 photographing angle is less than a predetermined angular speed, the digital device 100 can provide the first display mode for displaying a sensed image according to a photographing angle. In another embodiment, if the angular speed of the horizontal rotation from the a1 photographing angle to the a5 photographing angle exceeds the predetermined angular speed, the digital device 100 can provide the first display mode for displaying a sensed image according to a photographing angle. In particular, if the photographing angle of the camera unit 110 corresponds to the first angle range irrespective of the angular speed for a change of the photographing angle of the camera unit 110, the digital device 100 can provide the sensed image in the first display mode. In this case, the first display mode indicates a mode for providing the sensed image to the user 10 as it is without reversing the left/right or the top/bottom of the sensed image.

FIG. 6 to FIG. 8 is a diagram of embodiment when a photographing angle of a camera unit according to the present specification corresponds to a second angle range. FIG. 6 to FIG. 8 indicates when the camera unit 110 subsequently rotates after horizontally rotating from the a1 photographing angle to the a5 photographing angle in the aforementioned FIG. 5. Unlike the display device in the first angle range, the display device 100 can provide a sensed image to the user 10 in various modes according to a change of the photographing angle in the second angle range.

And, FIG. 6 to FIG. 8 indicates that a display is provided in various modes according to whether a change of the photographing angle of the camera unit exceeds a predetermined angular speed in the second angle range. In this case, the second angle range corresponds to angles exceeding an a6 photographing angle depicted in FIG. 6 to FIG. 8. For instance, the second angle range may correspond to the angles exceeding ±90 degrees on the basis of a predetermined point. And, the predetermined angular speed can be set by a user. The predetermined angular speed may indicate when the photographing angle changes more than twice for a T time in the present specification.

FIG. 6 is a diagram of a first embodiment when a photographing angle of a camera unit according to the present specification corresponds to a second angle range. More specifically, FIG. 6 (a) indicates a change of the photographing angle according to a horizontal rotation of the camera unit 110 and FIG. 6 (b) indicates that an image sensed by the camera unit 110 is provided to a user.

As depicted in FIG. 6 (a), it may take a T time for the camera unit 110 to change from an a6 photographing angle to an a10 photographing angle. In particular, the digital device 100 can recognize that the photographing angle of the camera unit 110 changes four times for the T time. In this case, as mentioned earlier, the digital device 100 can determine that the change of the photographing angle exceeds a predetermined angular speed.

And, as depicted in FIG. 6 (b), the digital device 100 can provide a first display mode for displaying a sensed image in the display unit 120. As mentioned earlier, the first display mode provided to a user may correspond to an image preview interface. In particular, the display device 100 can display images of an s6 to an s10 sensed by the camera unit 110 in the a6 photographing angle to the photographing angle a10 in the display unit 120 as it is without reversing the left and the right of the sensed image. This is because it is more natural to the user to display the sensed image without reversing the left and the right of the sensed image, although the camera unit 110 enters the second angle range while horizontally rotating with a high speed.

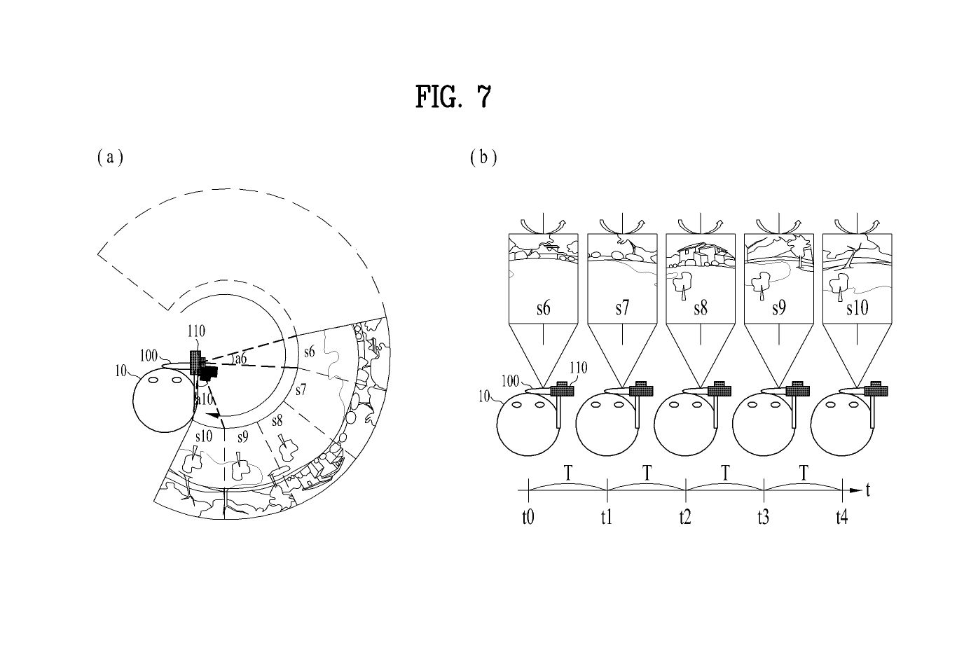

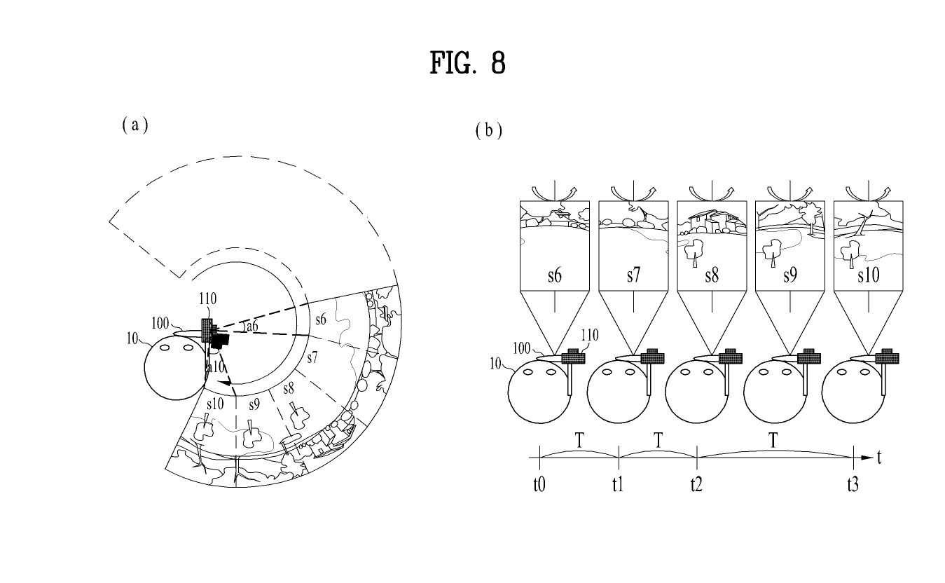

FIG. 7 is a diagram of a second embodiment when a photographing angle of a camera unit according to the present specification corresponds to a second angle range. More specifically, FIG. 7 (a) indicates a change of the photographing angle according to a horizontal rotation of the camera unit 110 and FIG. 7 (b) indicates that an image sensed by the camera unit 110 is provided to a user.

As depicted in FIG. 7 (a), it may take 4T times for the camera unit 110 to change from an a6 photographing angle to an a10 photographing angle. In particular, the digital device 100 can recognize that the photographing angle of the camera unit 110 changes four times for the 4T times. In this case, as mentioned earlier, the digital device 100 can determine that the change of the photographing angle is within a predetermined angular speed.

In this case, when the photographing angle of the camera unit is within the predetermined angular speed indicates when the horizontal rotation of the camera unit stops for a predetermined time. In this case, when the photographing angle of the camera unit is within the predetermined angular speed includes when at least a part of configuration elements of an image sensed by the camera unit is maintained as it is for the predetermined time. For instance, in case of sensing an image in the middle of taking a bus, while an external environment of the bus changes, an internal image of the bus is identically maintained. Hence, it may be within the predetermined angular speed.

Hence, as depicted in FIG. 7 (b), the digital device 100 can provide a second display mode for displaying images of which the left and the right of sensed images are reversed in the display unit 120. In particular, among the images s6 to s10 sensed by the camera unit 110 in a6 to a10 photographing angle, the digital device 100 can display s6 to s10 image of which the angular speed is recognized as decreasing in a manner of reversing the left/right of the s6 to s10 image. This is because if a rotation angular speed decreases in a second angle range while the camera unit 100 is horizontally rotated, it is more natural to display a sensed image in a manner of reversing the left/right of the sensed image compared to displaying the sensed image as it is for a user.

FIG. 8 is a diagram of a third embodiment when a photographing angle of a camera unit according to the present specification corresponds to a second angle range. More specifically, FIG. 8 (a) indicates a change of the photographing angle according to a horizontal rotation of the camera unit 110 and FIG. 8 (b) indicates that an image sensed by the camera unit 110 is provided to a user.

As depicted in FIG. 8 (a), the camera unit 110 can rotate from a6 photographing angle to a10 photographing angle with an angular speed, which is not constant. For instance, it may take 2T time for the camera unit 110 to rotate from a6 photographing angle to a8 photographing angle and it may take T time for the camera unit to rotate from a8 photographing angle to a10 photographing angle. In this case, the digital device 100 recognizes that the camera unit rotates from the a6 photographing angle to the a8 photographing angle within a predetermined angular speed and may determine that the camera unit rotates from the a8 photographing angle to the a10 photographing angle in a manner of exceeding the predetermined angular speed.

Hence, as depicted in FIG. 8 (b), the digital device can provide a second display mode configured to display a left-right reversed image of a sensed image in the display unit 120. In particular, the digital device 100 can display an image s6 and an image s7 sensed by the camera unit 110 from the a6 photographing angle to the a7 photographing angle, which is recognized as a change of a photographing speed is within a predetermined angular speed, in a manner of reversing the left/right of the s6 and the s7. And, the digital device 100 can display an image s8 to an image s10 sensed by the camera unit 110 from the a8 photographing angle to the a10 photographing angle, which is recognized as a change of the photographing speed exceeds the predetermined angular speed, in a manner of reversing the left/right of the s8 to the s10. This is because when horizontal rotation speed of the camera unit changes from slow to fast, if images are provided as it is again after showing images in a manner of reversing the left/right of the images, it may confuse a user. Hence, the s8 to the s10 image can be displayed in a manner of being reversed in order not to confuse the user.

Meanwhile, the aforementioned embodiment of FIG. 5 to FIG. 8 indicates that the camera unit 110 rotates to the right on the basis of a predetermined point. Regarding this, although it is not depicted in FIG. 5 to FIG. 8, if the camera unit 110 rotates to the left to the first angle range from a state of which the camera unit is already positioned at the second angle range, the digital device 100 can provide the first display mode configured to display a sensed image. For instance, in this case, the digital device can provide the first display mode irrespective of a rotation angular speed. This is because if an image is provided from the image of a side or a rear side of a user to the image of a front side of the user, it is more natural to provide the images as it is without reversing the left/right of the images.

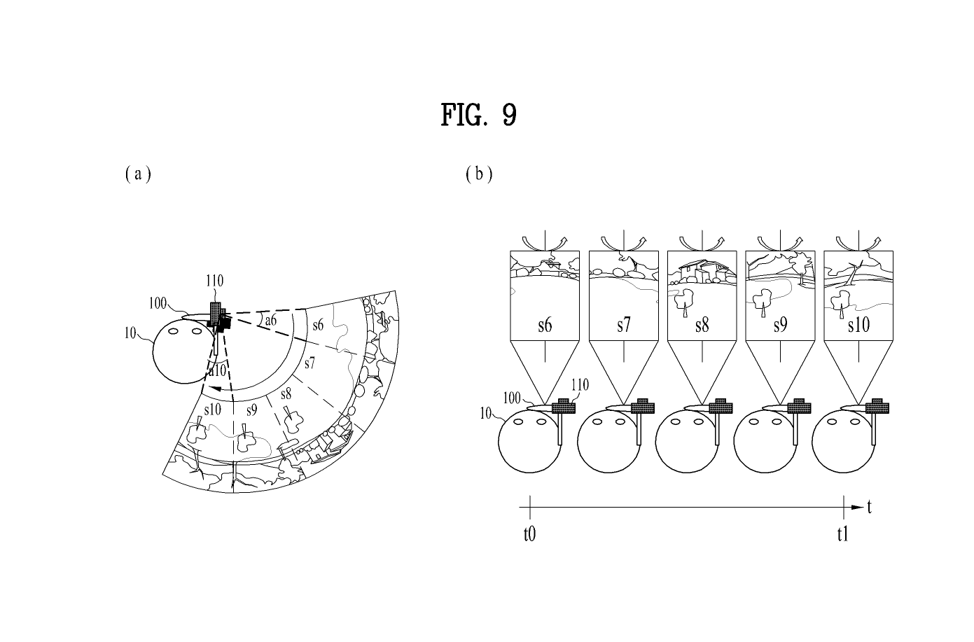

FIG. 9 is a diagram of a fourth embodiment when a photographing angle of a camera unit according to the present specification corresponds to a second angle range. More specifically, FIG. 9 (a) indicates a change of the photographing angle when the camera unit 110 horizontally rotates in a second angle range and FIG. 9 (b) indicates that an image sensed by the camera unit 110 is provided to a user.

Referring to FIG. 9 (a), the camera unit 110 can sense an image while horizontally rotating from a6 photographing angle to a10 photographing angle. In this case, unlike the aforementioned FIG. 5 to FIG. 8, the camera unit 110 does not sense images from a1 photographing angle to a5 photographing angle and starts sense images from the a6 photographing angle. For instance, as depicted in FIG. 9 (a), no image sensing in the first angle range may correspond to recognition for an absence of a vision of a user wearing a HMD in the first angle range. And, for instance, no image sensing in the first angle range may correspond that the camera unit 110 is deactivated in the first angle range.

And, referring to FIG. 9 (a), the camera unit 110 can perform a horizontal rotation in a second angle range. In particular, since the horizontal rotation of the camera unit 110 starts in the second angle range and ends in the second angle range, the digital device 100 can provide a left/right reversed image of a sensed image. This is because if the camera unit 110 performs a horizontal rotation in the second angle range, unlike when the camera unit sequentially performs the horizontal rotation from the first angle range to the second angle range, it is more natural to provide a user with a reversal effect identical to a mirror.

Meanwhile, although it is not depicted in FIG. 5 to FIG. 9, the digital device 100 can display an indicator indicating a photographing angle and a change of the photographing angle of the camera unit 110. This is aimed to provide a user 10 with an angle and an angular speed of an image currently taken since it is a situation that the user 10 detects surrounding environment in various angles via a rotation of the camera unit without turning a head of the user left and right.

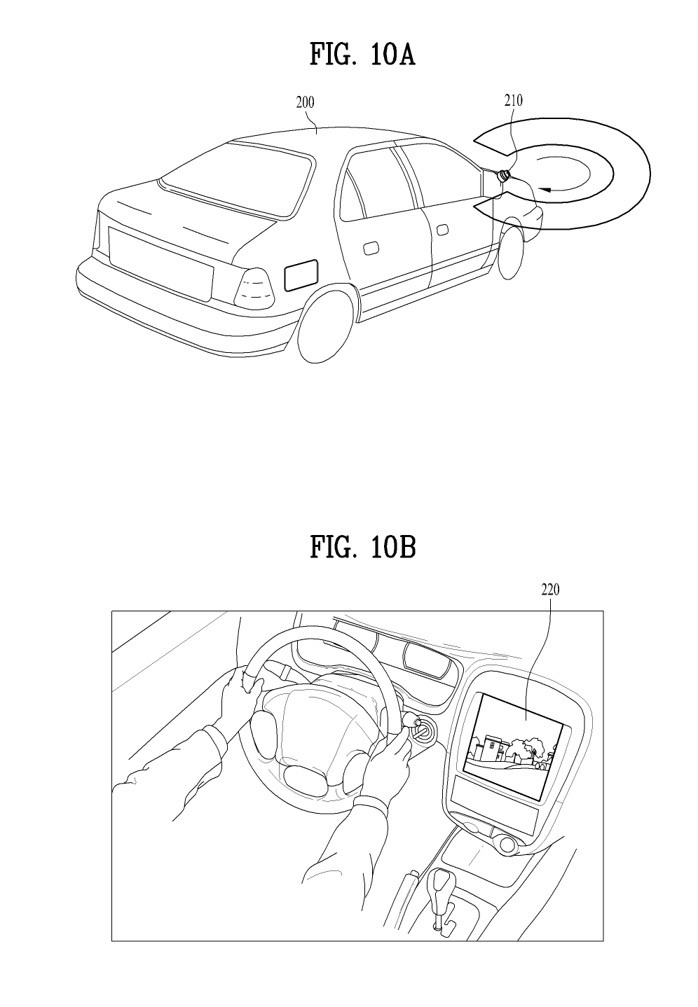

FIG. 10 is a diagram of an embodiment when a digital device according to the present specification is a camera installed in a vehicle. More specifically, FIG. 10a indicates a change of a photographing angle according to a horizontal rotation of a camera unit 210 installed in a side mirror of a vehicle 200 and FIG. 10b indicates that an image sensed by the camera unit 210 is provided to a user.

As depicted in FIG. 10a, the camera unit 210 capable of horizontally rotating can be installed in a side mirror of the vehicle 200. In particular, the camera unit 210 capable of horizontally rotating can sense an external environment in various angles. For instance, the camera unit 210 capable of horizontally rotating senses surrounding environment when the vehicle is parked and can sense a distance from a surrounding object.

As depicted in FIG. 10b, a user can check an image sensed by the camera unit 210 in a control box 220 positioned at an inside of the vehicle. In this case, the control box 220 may indicate a display screen capable of controlling navigation, a TV, and an air-conditioner of a car.

In one embodiment, the vehicle 200 can display a sensed image as it is when a photographing angle of the camera unit 210 corresponds to a first angle range. For instance, the first angle range may correspond to 0 to ±90 degrees. It is natural to provide the sensed image to a user as it is since the first angle range corresponds to a front side of the vehicle.

In another embodiment, when the photographing angle of the camera unit 210 corresponds to a second angle range, the vehicle 200 can display a left/right reversed image of a sensed image. In this case, the second angle range may correspond to an angle not within the first angle range. For instance, the second angle range may correspond to an angle exceeding ±90 degrees. This is because it is natural to provide the left-right reversed image of the sensed image to a user since the second angle range correspond to a rear side of the vehicle. Yet, as mentioned earlier in FIG. 5 to FIG. 8, in this case, an image can be reversely displayed according to a rotation angular speed in a manner of identically applying embodiment of FIG. 5 to FIG. 8.

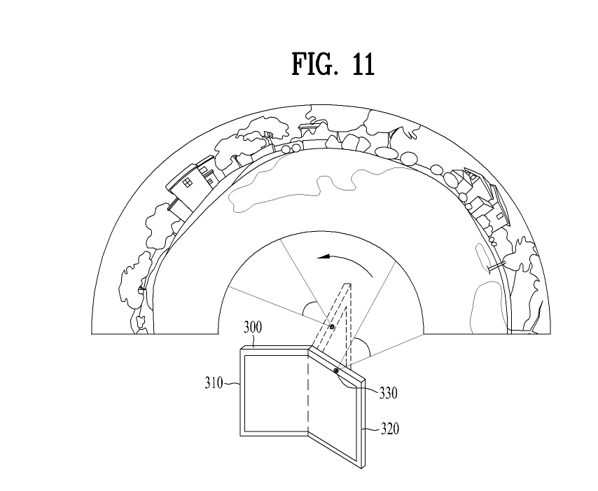

FIG. 11 is a diagram of an embodiment when a digital device according to the present specification corresponds to a foldable display device. More specifically, FIG. 11 indicates a change of a photographing angle of a foldable display device 300.

The foldable display device 300 of FIG. 11 can include a first body 310 and a second body 320. In this case, the first body 310 is positioned at the left of the foldable display device 300 and the second body 320 is positioned at the right of the foldable display device 300 and a camera unit 330 can be installed in the second body. And, a display screen can be installed throughout the first body 310 and the second body 320.

Referring to FIG. 11, the foldable display device 300 can change from a state that an internal angle formed by the first body and the second body is less than 180 degrees to a state that the internal angle exceeds 180 degrees. In this case, although it is not depicted in FIG. 11, the foldable display device 300 can display an image sensed by the camera unit 330 in a display screen 320 according to the internal angle formed by the first body 310 and the second body 320.

In one embodiment, when the internal angle formed by the first body and the second body is less than 180 degrees, the foldable display device 300 can display an image sensed according to a change of the internal angle formed by the first body and the second body as it is in the display screen. In another embodiment, when the internal angle formed by the first body and the second body exceeds 180 degrees, the foldable display device 300 can display a left/right reversed image of the image sensed according to a change of the internal angle formed by the first body and the second body in the display screen. For instance, the foldable display device 300 can provide various display modes according to a speed of an internal angle change in a manner of identically applying the aforementioned embodiment of FIG. 5 to FIG. 9.

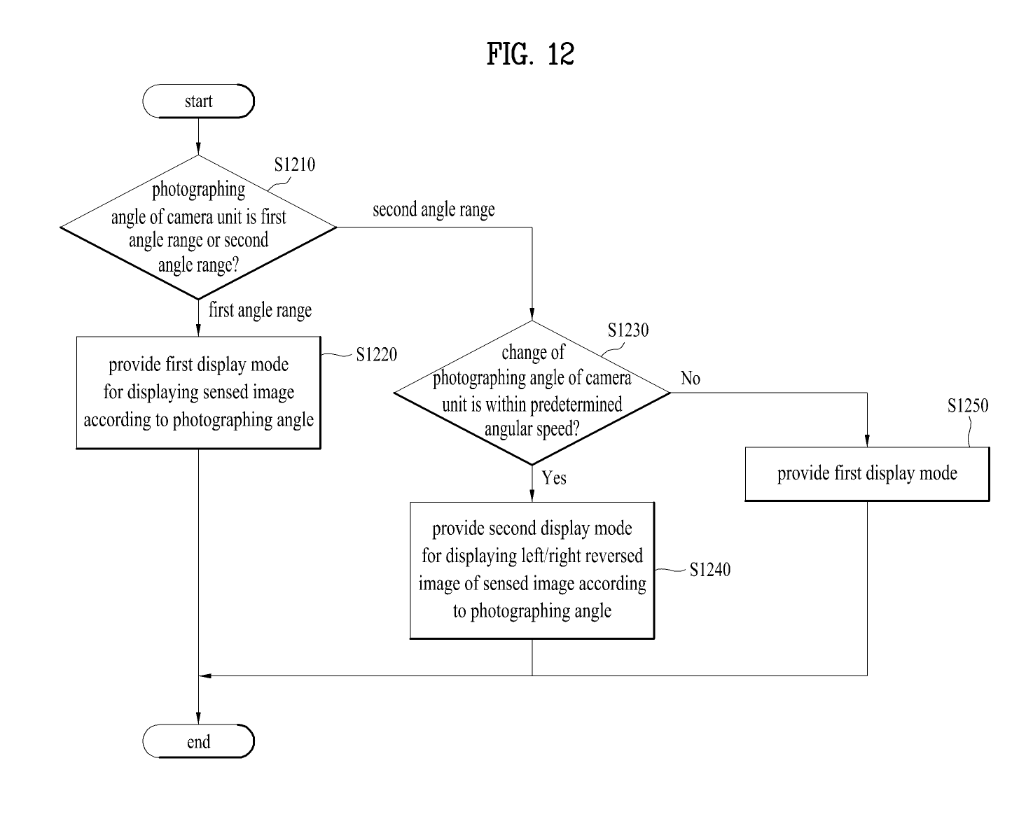

FIG. 12 is a flowchart of a method of controlling a digital device according to the present specification. Each step of FIG. 12 described in the following description can be controlled by a processor 140 of the digital device 100 depicted in FIG. 1.

First of all, a digital device can determine whether a photographing angle of a camera unit corresponds to a first angle range or a second angle range [S1210]. As mentioned earlier in FIG. 2, in this case, the camera unit is capable of horizontally rotating. And, in this case, the camera unit may have an view angle exceeding 180 degrees. For instance, the first angle range may correspond to 0 to ±90 degrees. And, for instance, the second angle range is an angle not within the first angle range and may correspond to an angle exceeding ±90 degrees.

In the step S1210, if the photographing angle corresponds to the first angle range, the digital device can provide a first display mode configured to display a sensed image according to the photographing angle [S1220]. More specifically, when the photographing angle corresponds to the first angle range, the digital device can provide the first display mode configured to display a sensed image according to the photographing angle irrespective of whether a change of the photographing angle corresponds to a predetermined angular speed. In this case, the first display mode may indicate when an image preview interface is provided.

In the step S1210, if the photographing angle corresponds to the second angle range, the digital device can determine whether a change of the photographing angle of the camera unit is within the predetermined angular speed [S1230]. As mentioned earlier in FIG. 6 to FIG. 8, if the photographing angle corresponds to the second angle range, the image preview interface provided according to whether the change of the photographing angle corresponds to the predetermined angular speed can vary.

In the step of S1230, when the change of the photographing angle is within the predetermined angular speed, the digital device can provide a second display mode configured to display a left/right reversed image of the sensed image according to the photographing angle [S1240]. For instance, if the camera unit is capable of horizontally rotating, the change within the predetermined angular speed may correspond that a horizontal rotation of the camera unit stops for a predetermined time. And, for instance, if an view angle of the camera unit exceeds 180 degrees, the change within the predetermined angular speed may include when at least a part of configuration elements of an image sensed by the camera unit is maintained for the predetermined time.

And, when the photographing angle changes with a speed less than the predetermined angular speed in the second angle range, since a user can recognize that an image displayed in the image preview interface corresponds to a surrounding environment positioned at a side or a rear of the user, it may be more natural to provide a left/right reversed image.

Meanwhile, as mentioned earlier in FIG. 8, when the photographing angle changes with a speed exceeding the predetermined angular speed within the predetermined angular speed, the digital device can provide a second display mode configured to display a left/right reversed image of a sensed image according to the photographing angle.

And, in the step of S1230, when the change of the photographing angle exceeds the predetermined angular speed, the digital device can provide the first display mode configured to display a sensed image according to the photographing angle [S1250]. This is because when the camera unit rotates with a fast angular speed in the second angle range, if the display mode suddenly changes from the first display mode in the first angle range to the second display mode, it may confuse a user.

For clarity of explanation, each diagram is explained in a manner of being divided. Yet, it is possible to design a new embodiment to implement the new embodiment by combining the embodiments, which are described in each of the diagrams. And, according to the necessity of those skilled in the art, designing a recording media readable by the computer, which has recorded a program for executing the previously explained embodiments, also belongs to a scope of a right.

A digital device and a method of controlling therefor according to the present specification may not limitedly apply to the composition and method of the aforementioned embodiments. The aforementioned embodiments may be configured in a manner of being selectively combined the whole of the embodiments or a part of the embodiments to achieve various modifications.

Meanwhile, a digital device according to the present specification and a method of controlling therefor can be implemented with a code readable by a processor in a recording media readable by the processor, which is equipped in a network device. The recording media readable by the processor may include all kinds of recording devices for storing data capable of being read by the processor. The examples of the recording media readable by the processor may include a ROM, a RAM, a magnetic tape, a floppy disc, an optical data storing device and the like. And, to implement in a form of a carrier wave such as a transmission via the internet and the like is also included. And, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on the both of the inventions can be complementally applied, if necessary.

What is claimed is:

1. A digital device, comprising:
a camera unit configured to sense an image;
a display unit configured to display the image sensed by the camera unit;
an angle sensing unit configured to sense a photographing angle of the camera unit; and
a processor configured to control the camera unit, the display unit, and the angle sensing unit,
wherein the processor is further configured to:
when the photographing angle of the camera unit corresponds to a first angle range, provide a first display mode for displaying a sensed image according to the photographing angle,
when the photographing angle of the camera unit corresponds to a second angle range,
if a change of the photographing angle of the camera unit exceeds a predetermined angular speed, provide the first display mode,
if the change of the photographing angle of the camera unit is within the predetermined angular speed, provide a second display mode for displaying a left/right reversed image of the sensed image according to the photographing angle,
if the change of the photographing angle of the camera unit changes from a speed less than the predetermined angular speed to the speed exceeding the predetermined angular speed, provide the second display mode.

2. The digital device of claim 1, wherein when the photographing angle of the camera unit corresponds to the second angle range indicates when the photographing angle of the camera unit changes from the first angle range to the second angle range.

3. The digital device of claim 1, wherein if the photographing angle of the camera unit changes from the second angle range to the first angle range, the processor is further configured to provide the first display mode.

4. The digital device of claim 1, wherein if the camera unit is capable of horizontally rotating, the processor is further configured to detect a horizontal rotation of the camera unit and map an angle to which the camera unit is horizontally rotated on the basis of a predetermined point to the photographing angle.

5. The digital device of claim 4, wherein when the change of the photographing angle of the camera unit is within the predetermined angular speed comprises when the horizontal rotation of the camera unit stops for a predetermined time.

6. The digital device of claim 4, wherein when the change of the photographing angle of the camera unit is within the predetermined angular speed comprises when at least a part of configuration element of the image sensed by the camera unit is maintained for a predetermined time.

7. The digital device of claim 4, wherein the predetermined point indicates one point in a direction at which the camera unit faces in a default state.

8. The digital device of claim 1, wherein if an view angle of the camera unit exceeds 180 degrees, the processor is further configured to sense an image via the camera unit, divide the view angle of the camera unit into at least one photographing angle, and map a part corresponding to the at least one photographing angle among the at least one photographing angle and the sensed image.

9. The digital device of claim 1, wherein the first display mode and the second display mode indicate providing an image preview interface of the image sensed by the camera unit.

10. The digital device of claim 9, wherein if the photographing angle of the camera unit provides the image preview interface in the second angle range, the processor is further configured to provide the second display mode.

11. The digital device of claim 10, wherein when the photographing angle of the camera unit provides the image preview interface in the second angle range indicates when the photographing angle of the camera unit does not provide the image preview interface in the first angle range.

12. The digital device of claim 1, wherein the digital device corresponds to a head mounted display (HMD).

13. The digital device of claim 12, wherein the photographing angle of the camera unit corresponds to an angle to which the camera unit horizontally rotates in a state that a user wears the HMD.

14. The digital device of claim 12, wherein when the photographing angle of the camera unit provides the image preview interface in the second angle indicates when the photographing angle of the camera unit indicates to recognize absence of a vision of a user wearing the HMD in the first angle range.

15. The digital device of claim 1, wherein the processor is further configured to display an indicator indicating the photographing angle and the change of the photographing angle.

16. The digital device of claim 1, wherein the second angle range corresponds to an angle not within the first angle range.

17. The digital device of claim 1, wherein if the digital device corresponds to a foldable display device, the photographing angle of the camera unit indicates an internal angle of a first body and a second body and wherein the second body is equipped with the camera unit.

18. The digital device of claim 1, wherein if the image sensed by the camera unit is captured, the processor is further configured to capture an image provided by the first display mode irrespective of the photographing angle of the camera unit.

19. The digital device of claim 1, wherein if the image sensed by the camera unit is contiguously captured, the processor is further configured to capture a video provided by the first display mode irrespective of the photographing angle of the camera unit.

20. A method of controlling a digital device, comprising the steps of:
if a photographing angle of a camera unit corresponds to a first angle range, providing a first display mode for displaying a sensed image according to the photographing angle;
if the photographing angle of the camera unit corresponds to a second angle range,
providing the first display mode when a change of the photographing angle of the camera unit exceeds a predetermined angular speed;
providing a second display mode for displaying a left/right reversed image of the sensed image according to the photographing angle when the change of photographing angle of the camera unit is within the predetermined angular speed; and
providing the second display mode when the change of the photographing angle of the camera unit changes from a speed less than the predetermined angular a speed to the speed exceeding the predetermined angular speed.
